(19) United States
(12) Patent Application Publication
(10) Pub. No.: US 2019/0276999 A1
(43) Pub. Date: Sep. 12, 2019

(54) PLOW ASSEMBLY WITH CUTTING EDGE CARTRIDGES

(71) Applicant: Stonebrooke Equipment, Inc., Burnsville, MN (US)

(72) Inventor: Jerry D. Holman, Lakeville, MN (US)

(21) Appl. No.: 16/296,296

(22) Filed: Mar. 8, 2019

Related U.S. Application Data
(60) Provisional application No. 62/640,956, filed on Mar. 9, 2018.

(51) Int. Cl. E01H 5/06; A01B 35/26; A01B 15/02; E02F 3/815

(52) U.S. Cl. CPC E01H 5/065; A01B 35/26; E02F 3/8157; E01H 5/062; A01B 15/02

(57) ABSTRACT

A plow assembly for mounting to a vehicle includes a mounting structure, a plow and a plurality of cutting edge cartridges attached to the blade. Each cutting edge cartridge includes a blade, a front plate, and a biasing element. The front plate is fixedly attached to a lower front surface of the plow, with the biasing element and the blade disposed between the plow and the front plate. The biasing element is disposed above an upper part of the blade and the blade is configured to slide in an upward and downward motion relative to the front plate and the plow. In response to a force applied to the blade, the blade slides upward relative to the backing plate and the plow and compresses the biasing element such that when the force is removed, the biasing element decompresses and urges and slides the blade downward.

### CROSS REFERENCE TO RELATED APPLICATION

The present application claims the filing benefits of U.S. provisional application Ser. No. 62/640,956, filed Mar. 9, 2018, which is hereby incorporated herein by reference in its entirety.

### FIELD OF THE INVENTION

The present invention relates generally to the field of plows that attach to a vehicle, such as a skid steer or truck or the like, and are operable to move snow or other materials.

### BACKGROUND OF THE INVENTION

It is known to provide a plow at a vehicle. It is also known to provide a plow with sectional plow blades at a vehicle.

### SUMMARY OF THE INVENTION

The present invention provides a plow assembly for mounting at a vehicle where the plow assembly includes a mounting structure. The mounting structure includes an attaching end and is configured to mount at a vehicle. A plow is pivotally attached at the attaching end of the mounting structure and pivotable about a generally vertical axis. The plow includes a plurality of cutting edge cartridges and each cutting edge cartridge includes a blade, a mounting plate or front plate, and a biasing element. The front plate is fixedly attached to the plow at a lower front surface of the plow. The blade is disposed at a front side of the front plate. The biasing element is disposed above an upper part or surface of the blade and the blade is configured to slide in an upward and downward motion relative to the front plate and the plow. In response to a force applied to the blade, the blade slides upward relative to the front plate and the plow and compresses the biasing element such that when the force is removed, the biasing element decompresses and urges and slides the blade downward.

These and other objects, advantages, purposes and features of the present invention will become apparent upon review of the following specification in conjunction with the drawings.

### BRIEF DESCRIPTION OF THE DRAWINGS

FIG. 1A is a front-perspective view of a plow assembly in accordance with the present invention;

FIG. 1B is another front perspective view of the plow assembly of FIG. 1A;

FIG. 2 is a side view of a plow assembly in accordance with the present invention;

FIG. 3 is a front view of a cutting edge cartridge of the plow assembly of FIG. 2;

FIG. 4 is an exploded view of the cutting edge cartridge of FIG. 3;

FIG. 5 is a side view of the cutting edge cartridge of FIG. 3;

FIG. 6 is an isometric view of the cutting edge cartridge of FIG. 3;

FIG. 7 is an isometric view of a blade of the cutting edge cartridge of FIG. 3;

FIGS. 8A and 8B are side views of the cutting edge cartridge, showing the biasing element decompressed and compressed;

FIGS. 9A and 9B are front and rear views of a plurality of cutting edge cartridges in accordance with the present invention;

FIG. 10 is a front view of a cutting edge cartridge incorporating a wave spring in accordance with the present invention;

FIGS. 11A and 11B are perspective views of a cutting edge assembly in accordance with the present invention, showing the biasing element decompressed and compressed, respectively;

FIG. 12 is an exploded view of the cutting edge cartridge of FIGS. 11A and 11B; and

FIGS. 13A and 13B are side views of the cutting edge cartridge of FIGS. 11A and 11B, respectively, showing the biasing element decompressed and compressed.

### DESCRIPTION OF THE PREFERRED EMBODIMENTS

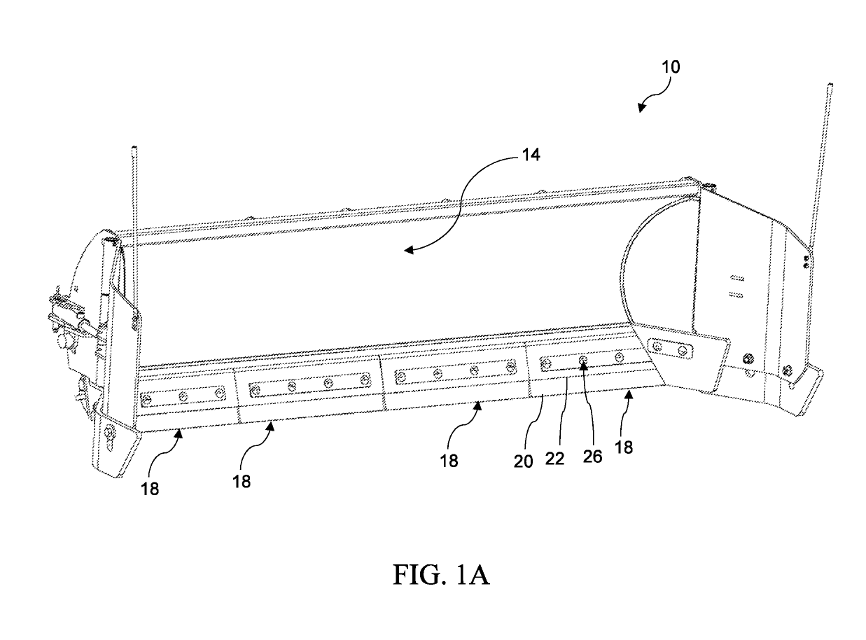

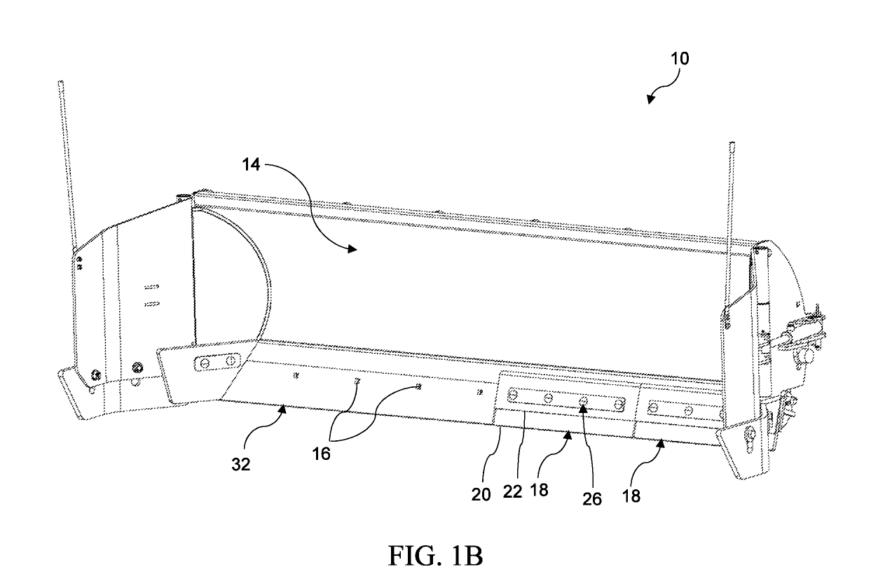

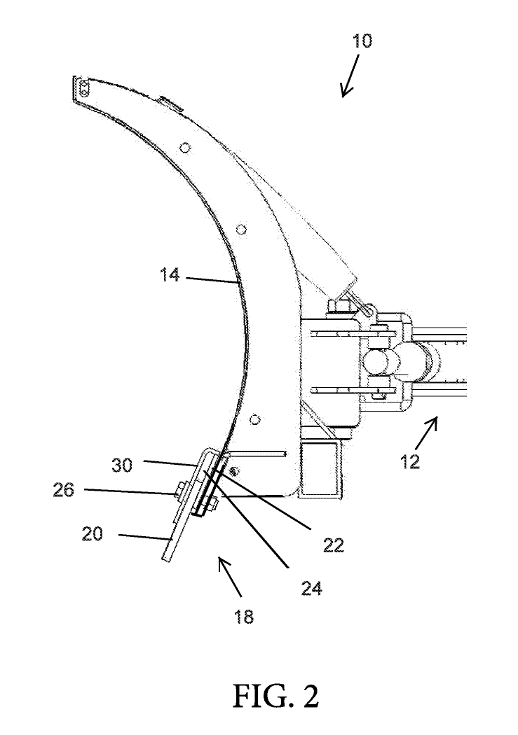

Referring now to the drawings and the illustrative embodiments depicted therein, a plow assembly 10 is configured to be mounted to a vehicle (not shown), such as a skid steer or pickup truck or other movable vehicle or the like, via mounting structure 12, such as an A-frame support or skid steer mount or the like (FIGS. 1A, 1B and 2). The plow assembly 10 includes a plow or mold board 14 that is pivotally mounted at the mounting structure 12 and is pivotable side to side about a generally vertical pivot axis via actuation of a respective one of two actuators (such as hydraulic cylinders or the like). The plow 14 may include a plurality of apertures 16 arranged in series along a bottom edge of the mold board 14 (FIG. 1B) for mounting cutting edge cartridges 18 thereat, as discussed below.

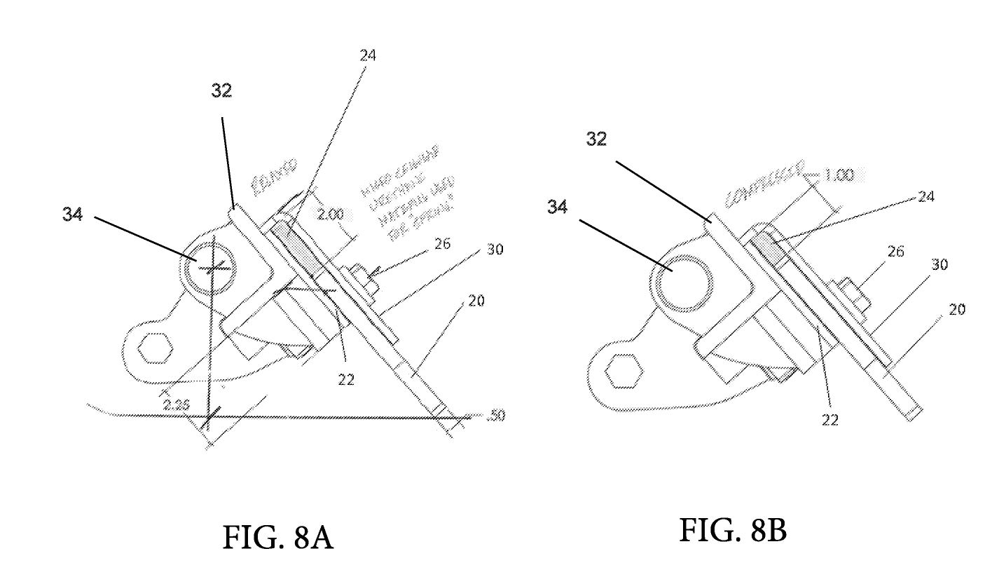

The plurality of cutting edge cartridges 18 of the plow assembly 10 are disposed along the bottom edge of the plow 14 such that when the plow 14 is lowered, the bottom edge of the cutting edge cartridges 18 will be at or near the ground. Each cutting edge cartridge 18 may include at least one blade 20, a mounting plate 22, and at least one biasing element 24. The mounting plate 22 is fixedly attached to the plow 14. The blade 20 is disposed at a front side of the mounting plate 22 and movably attached thereat via at least one fastener 26 that passes through at least one slot 28 in the blade. The slot 28 is elongated such that the blade 20 is slidable in an upward and downward motion relative to the mounting plate. The biasing element 24 is disposed above the blade 20 such that when a force is applied to the blade 20, such as the blade 20 encountering an object or undulation at the surface being plowed while plowing, the blade 20 slides upward relative to the plow 14 and compresses the biasing element 24. When the force is removed, the biasing element 24 decompresses and returns the blade 20 to its original position (see FIGS. 8A and 8B). This enables the plow assembly 10 to absorb the shock from impacting objects and to maintain uniform contact with the ground, as discussed below.

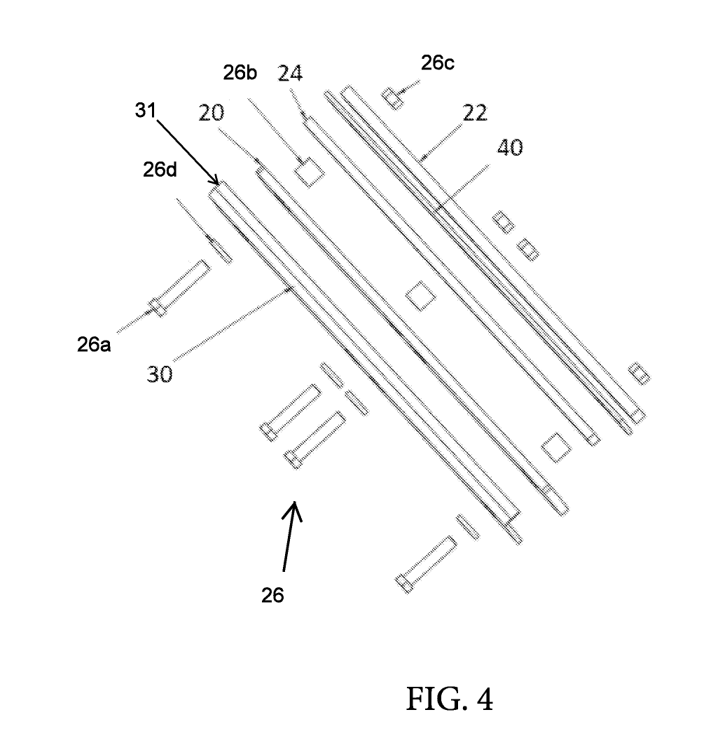

Each cutting edge cartridge 18 is fastened to the plow 14 via the mounting plate 22. The mounting plate 22 is fixedly attached to the plow, for example, by the fasteners 26, at a rear side of the mounting plate 22. As best shown in FIG. 4, the fasteners 26 each comprise a bolt 26a, a spacer or bushing 26b and a nut 26c. The spacer 26b is disposed through the aperture in the respective blade and engages the mounting plate 22 at one end and passes through an aperture at the front plate so as to engage a washer 26d at the forward side of a front plate 30 (optionally the spacer 26b may engage the rear surface of the front plate, whereby the washer 26d may not be included). The spacers 26b are dimensioned to slide along the slots 28 of the blade 20 and to provide or maintain the gap between the front plate 30 and the mounting plate 22 to allow the blades 20 to move up and down relative to the plates 22, 30 and the plow 14. Optionally, the edge cartridge 18 may include a shim 40 to set the spacing or gap in which the biasing element and cutting blade are disposed (FIG. 4).

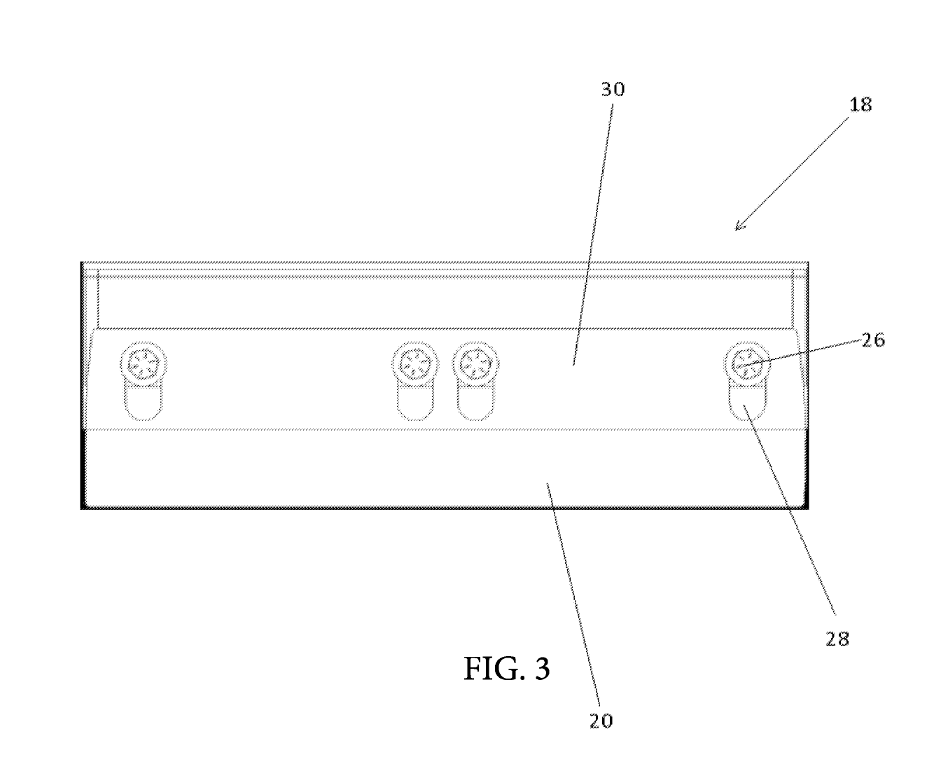

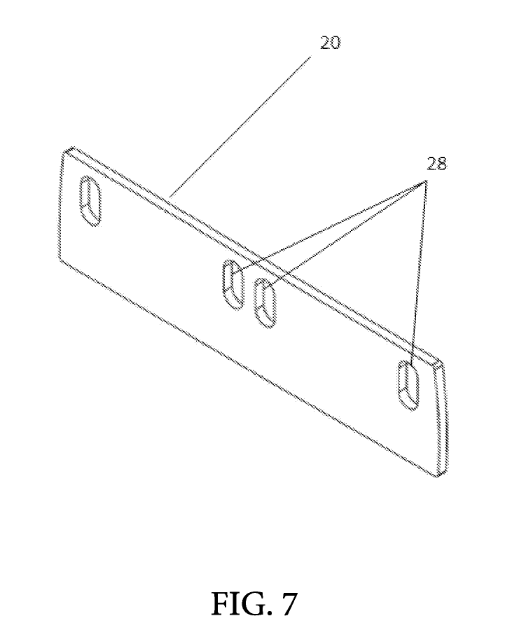

The blade 20 extends below the mounting plate 22 and below the lower edge of the plow 14 and is designed to slide along or near the ground. As shown in the illustrated embodiment, the blade 20 includes multiple slots or apertures 28. The blade 20 is retained at the mounting plate 22 via fasteners (bolts or the like) 26 positioned through the slots 28 and corresponding holes in the mounting plate 22. The slots 28 are elongated and allow the blade 20 to slide up and down relative to the fasteners 26 and mounting plate 22 (see FIG. 7). With the plow assembly 10 mounted to a vehicle, the blade 20 will naturally rest as low as the slots 28 will allow as a result of the biasing element 24 (see FIGS. 3-6).

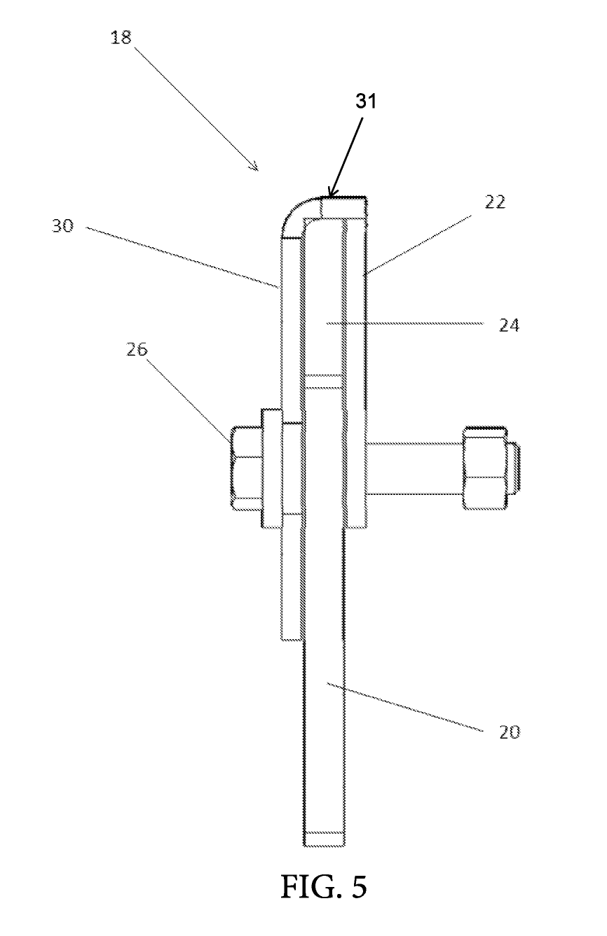

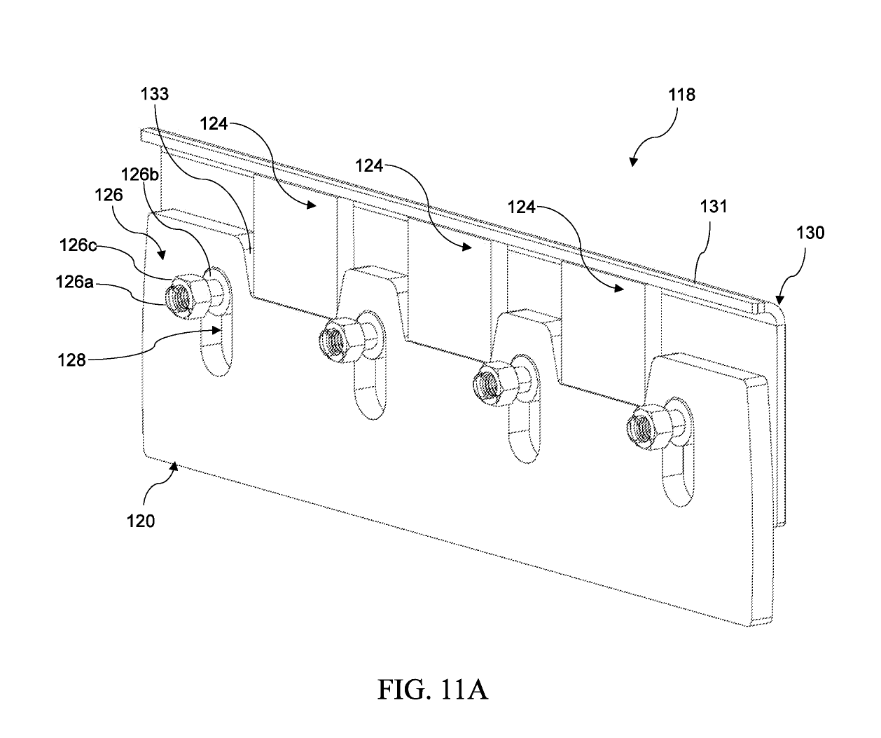

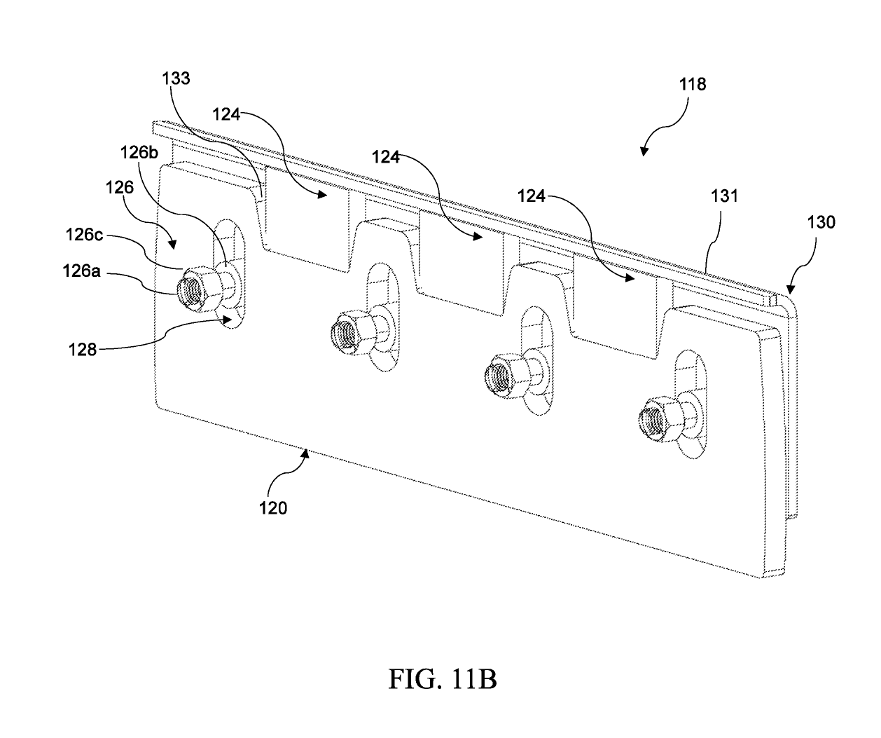

In the illustrated embodiment, the cutting edge cartridge 18 includes a front plate 30 (see FIG. 3) that is secured to the mounting plate 22 (so as to form a mounting element that attaches at the plow) and extends in front of the mounting plate 22 and downward, such that there is a gap between the mounting plate 22 and the front plate 30 approximately the thickness of the blade 20. The blade 20 is disposed between the front plate 30 and the mounting plate 22 such that, when slid upwards along the slots 28, the blade 20 will move within the gap between the front plate 30 and the mounting plate 22. The biasing element 24 is disposed within the gap and above the blade 20 so that it is held in place by the front plate 30 (including an upper portion 31 that extends over the biasing element 24 and closes the upper end of the gap), the mounting plate 22, and the blade 20 (see FIG. 5). Optionally, it is envisioned that the front plate 30 may be formed such that the mounting plate 22 may be omitted and the front plate 30 and blade 20 may be mounted directly to the plow 14 with fasteners 26, such as discussed below with respect to FIGS. 11A-13B.

When the blade 20 slides upward towards the plow 14, such as when the blade 20 encounters an object or bump along the ground that applies a force to the blade 20, the blade 20 compresses the biasing element 24. When the force is removed (such as when the plow has passed the obstacle), the biasing element 24 decompresses and pushes the blade 20 back to its original position at and engaging the ground. Similarly, when the blade 20 encounters a dip or depression along the ground, the biasing element 24 urges the blade 20 downward to maintain engagement with the ground. The biasing element 24 may be retained at the mounting plate 22 via a lip 31 at a top of the mounting plate 22 or front plate 30 and/or via adhesive or a fastener or the like.

Optionally, the mounting element may comprise a generally U-shaped element (including the rear plate and front plate and upper portion) that may be a unitarily formed metal element or structure or that may be two or more metal elements or structures welded or otherwise joined together), with the biasing element 24 received at an upper region of the mounting element and the blade 20 movably attached at the mounting element below the biasing element 24. Optionally, the mounting element may mount at the front surface of the lower portion of the plow blade (such as shown in FIGS. 1 and 2) or may attach at the rear surface of the lower portion of the plow blade (whereby the front plate is the attaching plate). Optionally, it is envisioned that the cartridge 18 may not include a mounting plate, whereby the plate 30 and fastener 26 attach to the lower portion of the plow 14 with the gap (that receives the biasing element and blade) established between the lower portion of the plow 14 and the front plate 30 (with the upper part 31 of the plate 30 and the length dimension of the spacer or bushing 26b reduced accordingly) (such as shown in FIGS. 11A-13B).

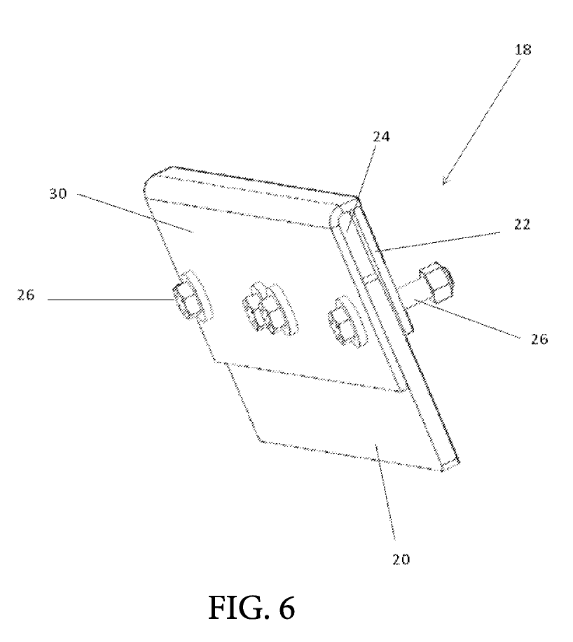

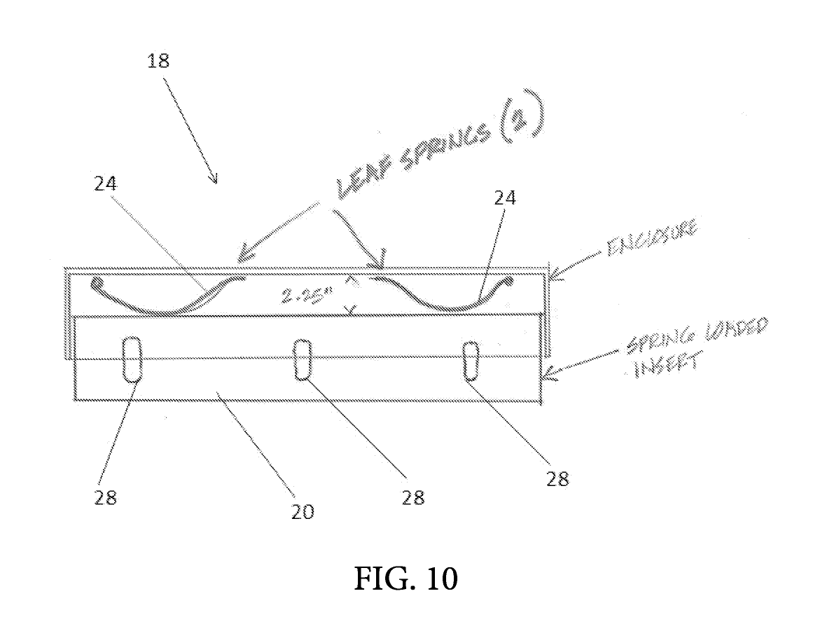

The biasing element 24, as shown in FIGS. 5-6, may include a rubber or other similar resilient element material (such as a microcellular urethane material or other composite material). Alternatively, as shown in FIG. 10, the biasing element 24 may include one or more wave springs or leaf springs. For example, the biasing element may include two leaf springs. The biasing element may also include one or more traditional springs.

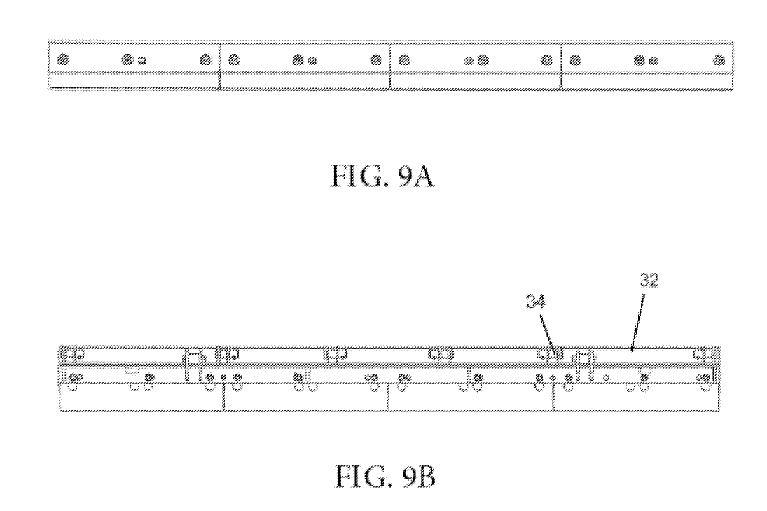

As can be seen with reference to FIGS. 8A, 8B and 9B, the cartridges 18 may be mounted to a structure 32 that is configured to mount the cartridges as an assembly or unit at and along the lower region of the plow. In the illustrated embodiment, the mounting structure 32 is configured to mount the cartridges via a plurality of bolts or pins 34 (FIG. 9B) that may affix or may pivotally mount the cartridges at the lower region of the plow 14. The assembly of cartridges 18 thus may be attached as a unit at the lower region or blade of the plow 14. The assembly includes a plurality of cutting edge blades 18 disposed along the attaching plate, with one or more biasing elements 24 disposed at and above the blades 20 to provide the biasing of the blades 20 toward the ground during use of the plow 14.

The plow assembly 10 may include any number of cutting edge cartridges 18 (see FIGS. 9A and 9B). Optionally, a single cartridge 18 may include multiple blades 20 and multiple respective biasing elements 24, with each blade 20 having at least one slot 28 therethrough for receiving a respective bolt or fastener, as discussed above. Optionally, a cartridge unit 18 or assembly may include multiple blades 20 disposed below a single or common biasing element 24 (such as a rubber or similar resilient compressible element), whereby each blade 20 compresses a respective part of the common biasing element 24 as the plow 14 and blades 20 move along the surface being plowed. For example, the configuration shown in FIGS. 9A and 9B may include a single compressible resilient biasing element 24 disposed along and above two or more of the plurality of cutting edge blades 20.

Referring now to FIGS. 11A-13B, another example of a cutting edge cartridge 118 in accordance with the present invention is shown. Except as provided below, the cutting edge cartridges 118 are otherwise similar to the cutting edge cartridges 18 described above, such that a detailed discussion of the cutting edge cartridges 118 and alternative designs and implementations need not be repeated herein.

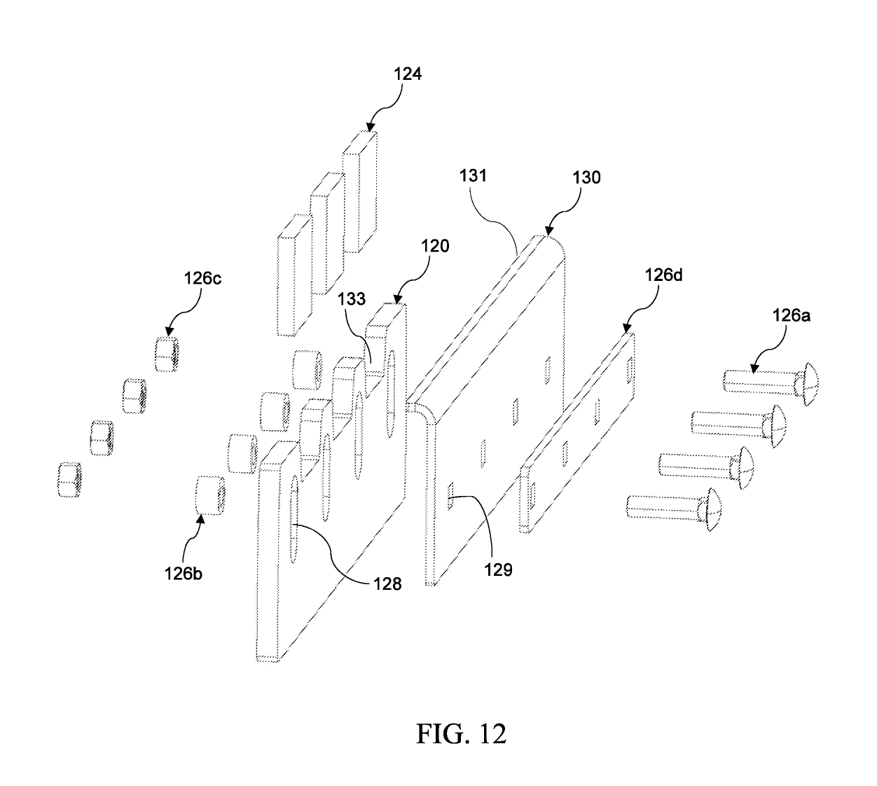

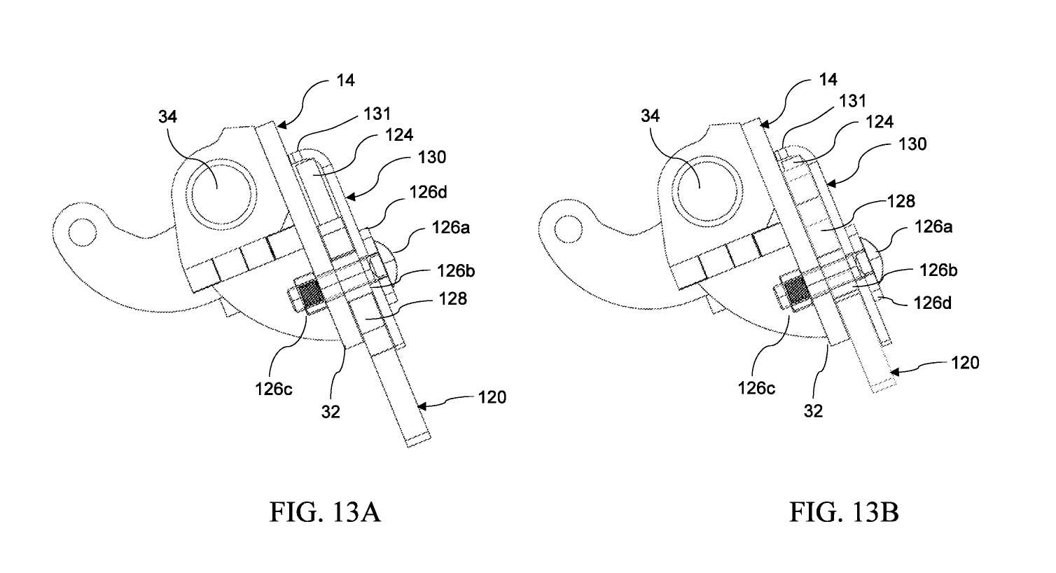

Each of the cutting edge cartridges 118 is configured to be mounted directly to the plow 14 via the apertures 16 formed along the lower portion of the plow 14, and includes a blade 120, a plurality of biasing elements 124, and a front plate 130. Thus, unlike the cartridge 18 described above, the cartridge 118 does not include a mounting plate or rear plate disposed between the blade 120 and the plow 14. Each cutting edge cartridge 118 is fastened to the plow by fasteners 126 at a rear side of the mold board 14 (FIGS. 13A and 13B). As best shown in FIG. 12, the fasteners 126 each comprise a bolt 126a, a spacer or bushing 126b, and a nut 126c. Optionally, the fasteners 126 may include a washer plate 126d.

The spacers 126b are disposed within the slots 128 in the respective blade 120 and are configured to engage the mold board 14 at one end and pass through the front plate 130 at the other end. The spacers 126b are dimensioned to slide along the slots 128 of the blade 120 and to provide or maintain the gap between the front plate 130 and the mold board 14 to allow the blades 120 to move up and down relative to the front plate 130 and the plow. Particularly, the spacers 126b may be cylindrical and an outside diameter of each of the spacers 126b may have clearance within the slot 128, while a thickness of the spacer 126b is greater than a thickness of the blade 120 so that opposite ends of the spacer 126b protrude from opposite sides of the blade 120 and contact the rear face of the front plate 130 and the front face of the mold board 14. Optionally, the cutting edge cartridge 118 may include a shim (not shown) to set the spacing or gap in which the biasing element and cutting blade are disposed.

In the illustrated embodiment, the front plate 130 (see FIGS. 13A and 13B) of the cutting edge cartridge 118 is secured to the mold board 14 and extends in front of the mold board 14 and downward, such that there is a gap between the mold board 14 and the front plate 130 corresponding to the thickness of the spacer 126b. The blade 120 is disposed between the front plate 130 and the mold board 14 such that, when the blade slides upwards along the slots 128, the blade 120 will move within the gap between the front plate 130 and the mold board 14. The biasing elements 124 are disposed within the gap and above the blade 120 so that it is held in place by the front plate 130, the mold board 14, and the blade 120 (see FIGS. 3A and 3B). The front plate 130 includes an upper portion or lip 131 that extends over the biasing elements 124 and closes the upper end of the gap.

The biasing elements 124, as shown in FIGS. 11A and 11B, may comprise a rubber or other similar resilient deformable element or material (such as a microcellular urethane material or other composite material). In the illustrated example, the cartridge 118 includes a plurality of the biasing elements 124 spaced apart within the gap. Here, each of the biasing elements 124 is individually received within a notch or recess 133 formed in the top of the blade 120, such that the upper portion of the blade 120 between the recesses minimizes lateral movement of the respective biasing elements 124. The recesses may be angled or tapered (such that the recess has a larger width at its upper end than the width at its lower end) so as to allow for room for expansion of the biasing elements 124 as they are compressed as the blade is urged upward. Alternatively, a single biasing element 124 may extend continuously along a length of the blade 120.

Therefore, the present invention provides a snow plow assembly system with a plurality of cutting edge cartridges that absorb impact from obstacles or that accommodate unevenness in the ground and allow the plow to maintain better contact with the ground, allowing the plow edges to scrape the pavement much cleaner and thus reducing salt usage. The cartridges include a mounting element or receiving element that fixedly attaches at the plow and receives the biasing element and plow blade therein. This helps reduce breakage of components and increases the effectiveness of the plow. Although shown and described as being a plow assembly, the cutting edge cartridges of the present invention are suitable to be mounted to any standalone plow by fastening the mounting plate or front plate directly to the plow. As such, it is envisioned that the cutting edge cartridges may be attached along a lower edge of an already existing plow, such that the cutting edge cartridges may be provided as an aftermarket kit or assembly that enhances the effectiveness of a given plow or mold board.

Changes and modifications in the specifically described embodiments can be carried out without departing from the principles of the invention, which is intended to be limited only by the scope of the appended claims, as interpreted according to the principles of patent law including the doctrine of equivalents.

1. A plow assembly for mounting at a vehicle, the plow assembly comprising:
a mounting structure comprising an attaching end and configured to mount at a vehicle;
a plow attached at the attaching end of the mounting structure;
a plurality of cutting edge cartridges disposed at a lower portion of the plow;
wherein each cutting edge cartridge comprises a blade, a front plate, and at least one biasing element;
wherein the front plate is spaced from the plow so as to provide a gap between the front plate and the plow;
wherein the at least one biasing element is disposed at an upper region of the gap;
wherein the blade is movably disposed in the gap below the at least one biasing element;
wherein the blade is configured to move upward and downward relative to the front plate and the plow; and
wherein, with the mounting structure mounted to the vehicle, in response to a force applied to the blade, the blade moves upward relative to the front plate and the plow and compresses the biasing element, and wherein, when the force is removed, the biasing element decompresses and urges and moves the blade downward relative to the front plate and the plow.

2. The plow assembly of claim 1, wherein the blade of each cutting edge cartridge comprises at least one elongated slot, and wherein the cutting edge cartridge is attached at the lower portion of the plow via at least one fastener that is received through the respective slot in the blade, and wherein the blade is movable relative to the fastener and the front plate and the plow via movement of the fastener along the slot.

3. The plow assembly of claim 2, wherein the fastener extends through an aperture in the front plate and through an aperture at the lower portion of the plow to fixedly attach the front plate of the cutting edge cartridge at the plow.

4. The plow assembly of claim 2, wherein the blade comprises at least two elongated slots that each receive a respective fastener therethrough to movably attach the blade to the front plate and the plow.

5. The plow assembly of claim 2, wherein the at least one fastener includes a spacer movably disposed within the slot and between the front plate and the plow.

6. The plow assembly of claim 5, wherein the spacer has a greater thickness than the blade, whereby a first end of the spacer contacts the front plate and a second end of the spacer contacts the plow.

7. The plow assembly of claim 1, wherein each cutting edge cartridge comprises a single blade and a plurality of the biasing elements that independently engage and urge the blade downward relative to the front plate and the plow.

8. The plow assembly of claim 1, wherein the blade includes a recess at an upper region thereof and the at least one biasing element is at least partially received within the recess.

9. The plow assembly of claim 8, wherein a spacing lip is provided at an upper end of the front plate that at least partially spans the gap between the plow and the front plate, and wherein the at least one biasing element is disposed between the spacing lip and the blade.

10. The plow assembly of claim 1, wherein each cutting edge cartridge is pivotally mounted to the lower portion of the plow.

11. A plow assembly for mounting at a vehicle, the plow assembly comprising:
a mounting structure comprising an attaching end and configured to mount at a vehicle;
a plow attached at the attaching end of the mounting structure;
a plurality of cutting edge cartridges disposed along a lower portion of the plow;
wherein each cutting edge cartridge comprises a blade, a front plate, and a biasing element;
wherein the front plate is fixedly attached at the lower portion of the plow;
wherein the blade is movably attached at the front plate;
wherein, with the mounting structure mounted to the vehicle, the biasing element is disposed above the blade;
wherein, with the mounting structure mounted to the vehicle, the blade is configured to move in an upward and downward motion relative to the front plate and the plow; and
wherein, with the mounting structure mounted to the vehicle, in response to a force applied to the blade, the blade moves upward and compresses the biasing element, and wherein, when the force is removed, the biasing element decompresses and urges and moves the blade downward.

12. The plow assembly of claim 11, wherein the biasing element comprises a compressible resilient material.

13. The plow assembly of claim 11, wherein the front plate is disposed at the plow such that a gap exists between the plow and the front plate, and wherein the biasing element is disposed in the gap between the front plate and the plow and the blade is partially disposed in the gap between the front plate and the plow.

14. The plow assembly of claim 13, comprising an upper lip that extends over the biasing element between the front plate and the plow to retain the biasing element in the gap and limit upward movement of the biasing element.

15. The plow assembly of claim 14, wherein the upper lip is formed at an upper end of the front plate, and wherein the upper lip engages the plow to establish the gap between the front plate and the plow.

16. The plow assembly of claim 11, wherein the plow is pivotally attached at the attaching end of the mounting structure and is pivotable about a generally vertical axis.

17. The plow assembly of claim 11, wherein the biasing element is received within a recess at an upper region of the blade.

18. A method of attaching and using a plurality of movable cutting edges at a plow, the method comprising:
providing a plow that is configured for attachment at a vehicle;
providing a plurality of cutting edge cartridges, wherein each cutting edge cartridge comprises a blade, a front plate, and at least one biasing element;
attaching the cutting edge cartridges at a lower region of the plow so that the front plate is spaced from the plow so as to provide a gap between the front plate and the plow;
with the cutting edge cartridges attached at the lower region of the plow, the at least one biasing element is disposed at an upper region of the gap; and
with the cutting edge cartridges attached at the lower region of the plow, the blade is movably disposed in the gap below the at least one biasing element.

19. The method of claim 18, further comprising:
mounting the plow to a vehicle and, with the plow mounted to the vehicle, plowing a ground surface;
while plowing the ground surface, and in response to a force applied to the blade, moving the blade upward relative to the front plate and the plow so as to compress the biasing element; and
responsive to the force being removed from the blade, decompressing the biasing element to urge and move the blade downward relative to the front plate and the plow.

20. The method of claim 18, wherein providing a plurality of cutting edge cartridges comprises providing a kit comprising a plurality of cutting edge cartridges for attaching at a lower region of the plow as an aftermarket kit.
